(19) United States
(12) Patent Application Publication
(10) Pub. No.: US 2002/0083434 A1
(43) Pub. Date: Jun. 27, 2002

(54) Method and system for automated reporting in a communications network

(76) Inventors: Stephen R. Bacso, Kitchener (CA); Rene J. Juneau, Thornhill (CA); Sanjeev Shankar, Waterloo (CA); Bruce D. Scanlan, Waterloo (CA)

Correspondence Address: SHUMAKER & SIEFFERT, P. A., 8425 SEASONS PARKWAY, SUITE 105, ST. PAUL, MN, 55125, US

(21) Appl. No.: 09/991,565

(22) Filed: Nov. 20, 2001

(30) Foreign Application Priority Data
Nov. 20, 2000 (CA) 2,326,368

(51) Int. Cl. H04N 7/16; H04H 9/00; H04N 7/025; H04N 7/10; G06F 3/00; H04N 5/445

(52) U.S. Cl. 725/9; 725/14; 725/47; 725/34

(57) ABSTRACT

The present invention relates to a method and system for automated reporting in a communications network. In accordance with the present invention, there is provided a method for automated reporting in a communications network, the method comprising the steps of: collecting user data related to content targeting; and reporting said collected data to provide improved targeting. In accordance with the present invention, there is provided a method for automated reporting in a communications network, the method comprising the steps of: monitoring the programming stream for opportunities and content descriptors; determining the source for alternate content as described previously; matching the opportunity to the available content and the viewer characteristics; presenting the content to the viewer; and updating the secure audit log with the viewing result.

### PRIORITY CLAIM

The present application claims priority from Canadian Patent Application 2,326,368 filed Nov. 20, 2000, and pending U.S. patent application Ser. No. 09/687,449 filed Oct. 13, 2000 entitled ‘Method and System for Targeted Advertising’, the contents of which are herein incorporated by reference.

### FIELD OF THE INVENTION

The present invention relates generally to reporting methods in data systems, and more particularly to a method and system for automated reporting in a communications network.

### BACKGROUND OF THE INVENTION

While television is still by far the most popular medium for entertainment and information, television technology had until recently remained relatively unchanged since its introduction in the 1950s. However, the recent emergence of digital television environments has reflected the convergence of conventional television broadcasting and the digital format.

Digital television provides much more selection for viewers. Broadcasters and other providers of content are highly interested in end-user feedback to more accurately target content to improve service, and therefore revenue.

The problem is that to properly review and evaluate viewing habits of end-users reporting methods that exist to indicate the delivery and presentation of targeted content lack flexibility and detail, and are insufficient to determine with any accuracy what content was delivered and played. What is needed is a method that enables Network Operators to design and build custom reporting structures based on the dynamics of environmental economics, and provide reporting and feedback through relatively low-bandwidth and expensive telephone connections, as is the case for cable television, satellite and microwave systems, securely and at a reasonable cost.

As well, there are no standards or consistencies across platforms. Network Operators, which typically have heterogeneous networks, deploying a reporting solution from a specific provider would only have the solution supported on a portion of their network.

Any proposed solution should make innovative use of legacy receiver facilities and technology, work with official and de-facto standards for transmission and interactivity, and be adaptable and usable by new receivers while maintaining compatibility and interoperability with legacy systems. As well, the solution should enable passive accumulation and reporting in a secure and confidential environment, and be highly adaptable to changing needs.

The solution should enable providers to consolidate delivery records and feedback for multiple disparate networks and components, and work in an interactive or passive environment. Any proposed solution should be capable of handling the above considerations in end-user equipment provided at a reasonable cost, and with consideration for any existing technological system limitations.

For the foregoing reasons, there is a need for an improved method of reporting in a communications network.

### SUMMARY OF THE INVENTION

The present invention is directed to a method and system for automated reporting in a communications network.

In accordance with the present invention, there is provided a method for automated reporting in a communications network, the method comprising the steps of: collecting user data related to content targeting; and reporting said collected data to provide improved targeting.

In accordance with the present invention, there is provided a method for automated reporting in a communications network, the method comprising the steps of: monitoring the programming stream for opportunities and content descriptors; determining the source for alternate content as described previously; matching the opportunity to the available content and the viewer characteristics; presenting the content to the viewer; and updating the secure audit log with the viewing result.

The invention enables Network Operators to determine/create a custom reporting structure based on the dynamics of environmental economics.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a system for targeted content presentation in communications networks according to an embodiment of the present invention;

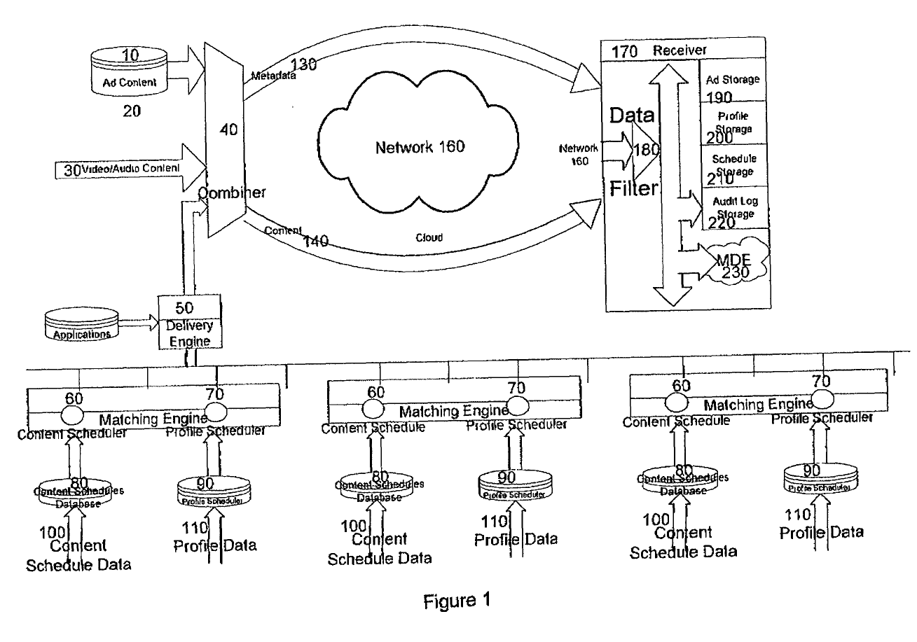

FIG. 2 shows an automated reporting system in accordance with the present invention;

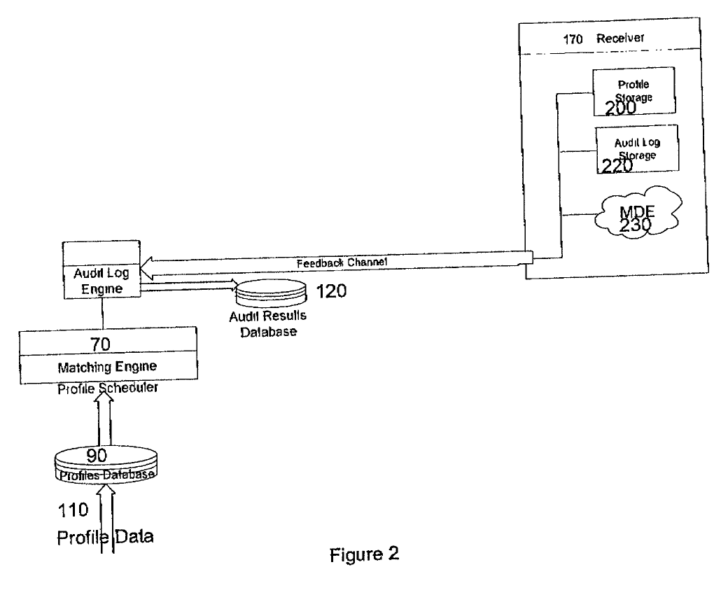

FIG. 3 shows a system for presenting target content system in accordance with the present invention;

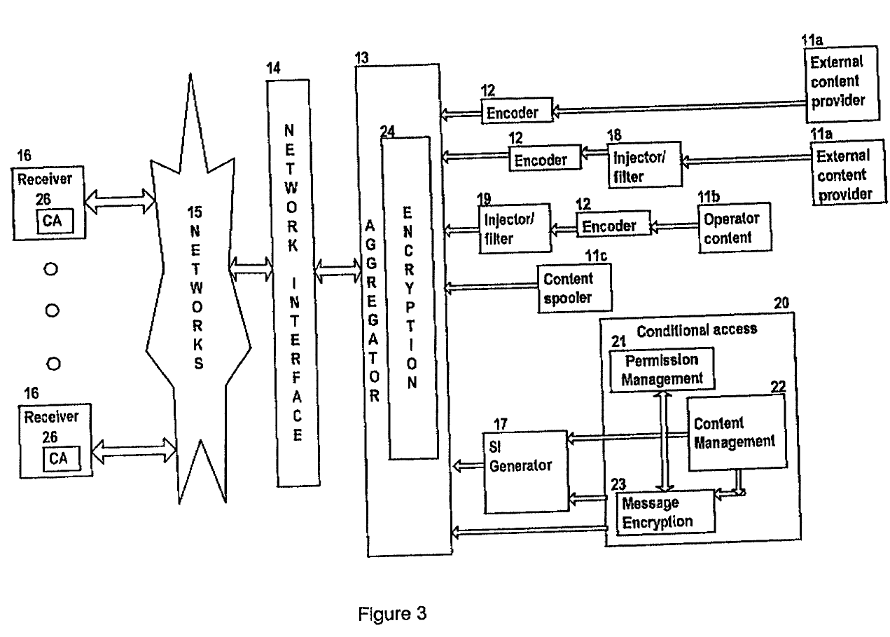

FIG. 4 shows a receiver system in accordance with the present invention;

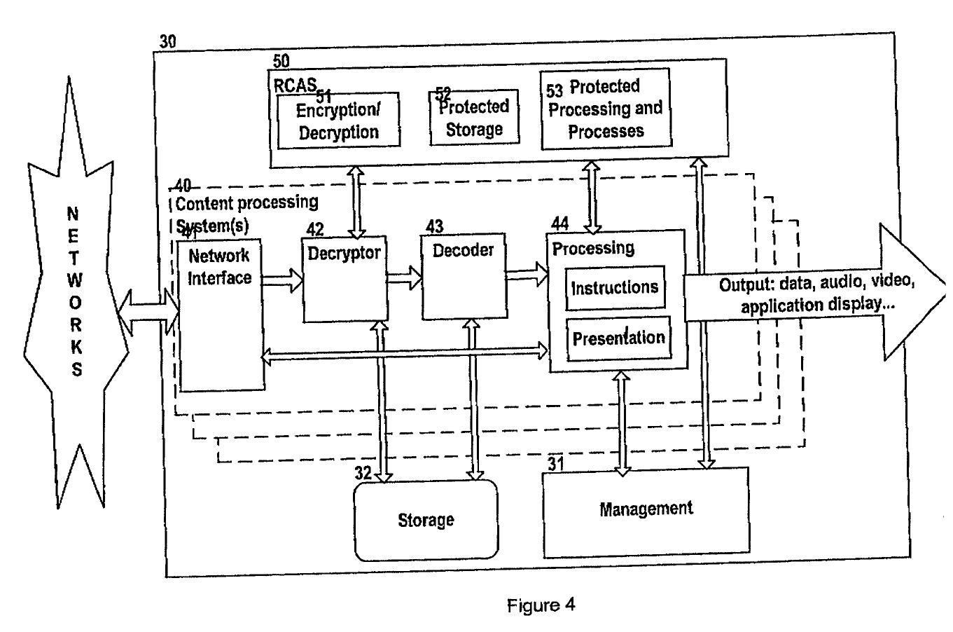

FIG. 5 shows a method for presenting targeted content in accordance with the present invention;

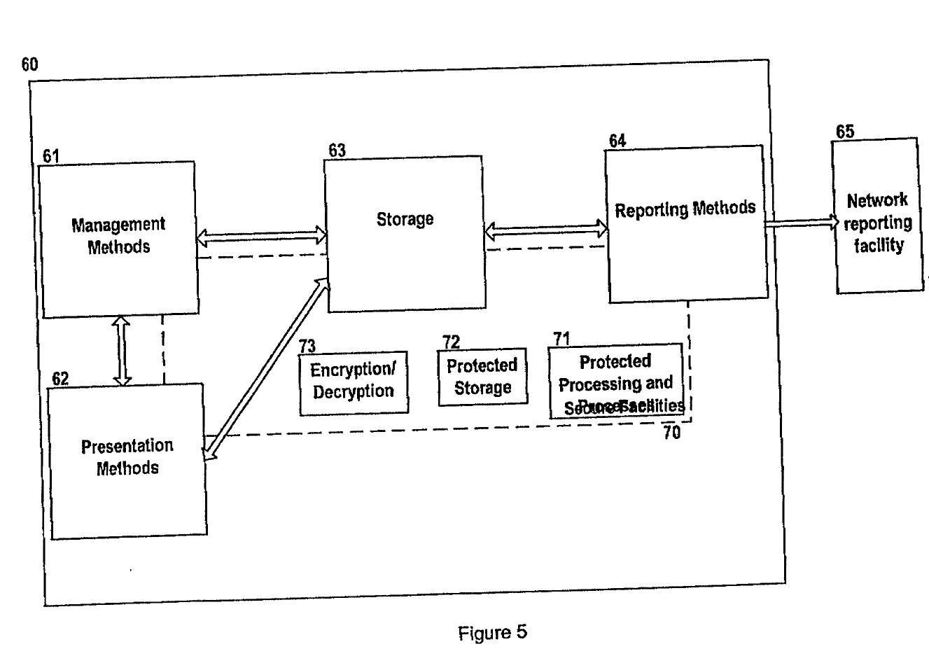

FIG. 6 shows a method for presenting targeted content in accordance with the present invention;

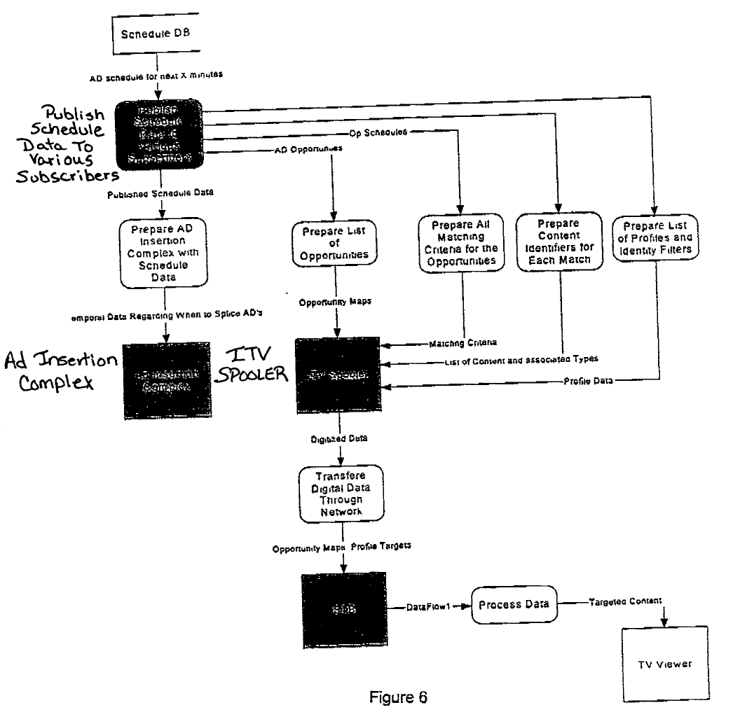

FIG. 7 shows a method for presenting targeted content in accordance with the present invention;

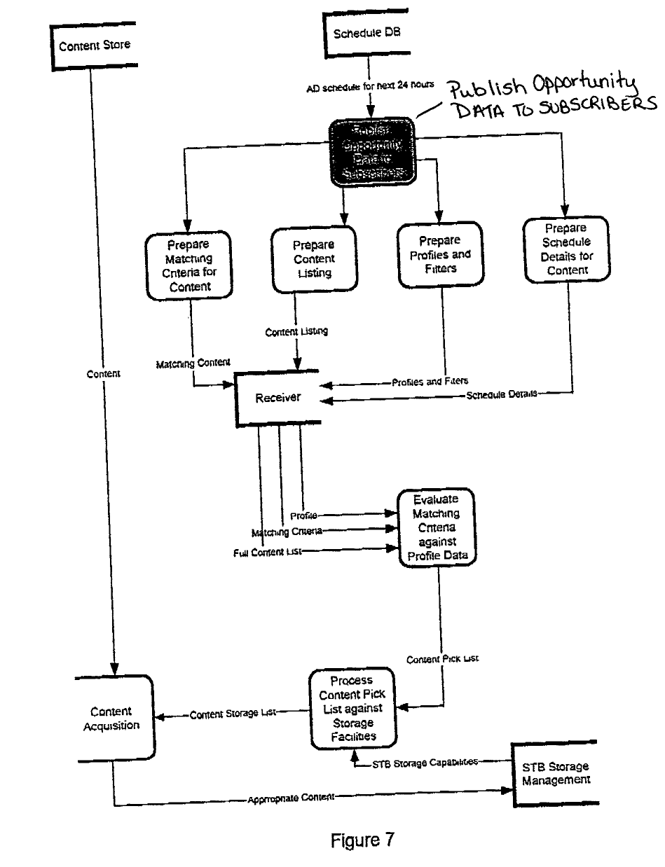

FIG. 8 shows a method for presenting targeted content system in accordance with the present invention;

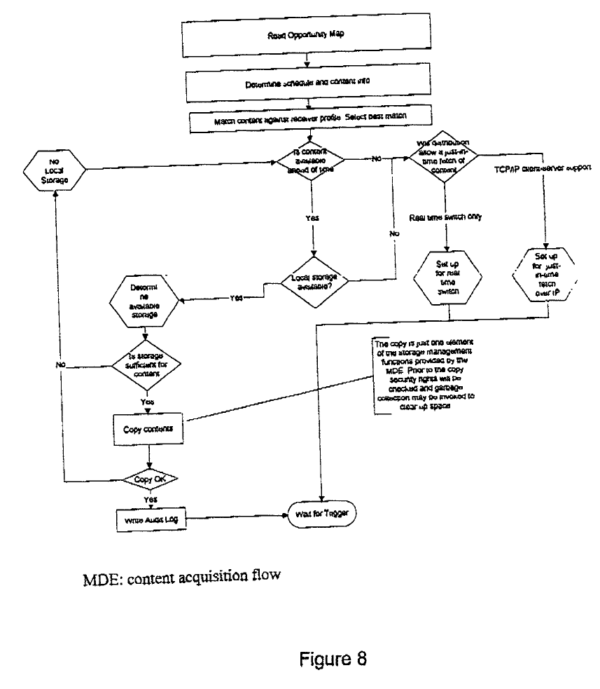

FIG. 9 shows a method for presenting targeted content system in accordance with the present invention;

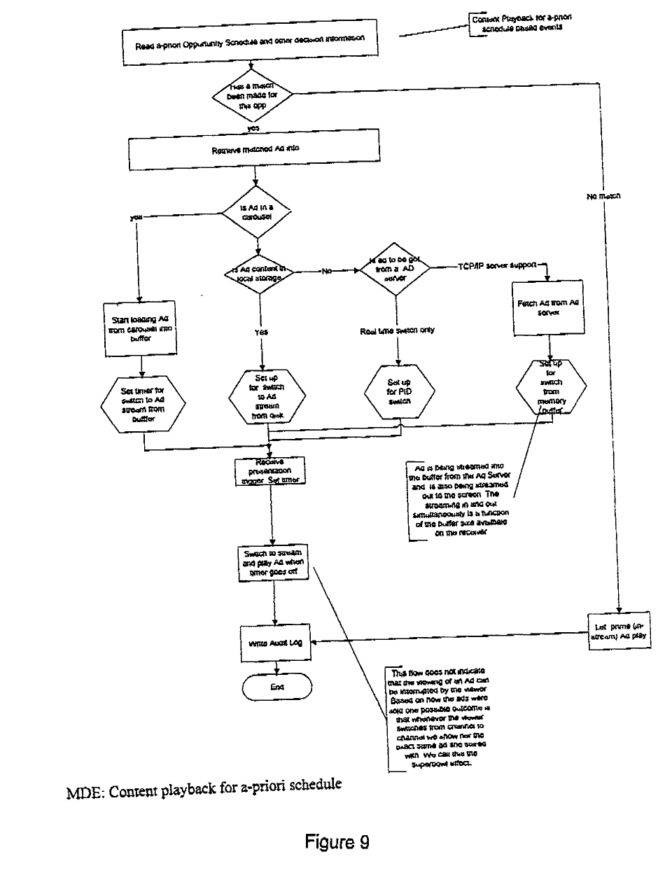

FIG. 10 shows a method for presenting targeted content system in accordance with the present invention; and

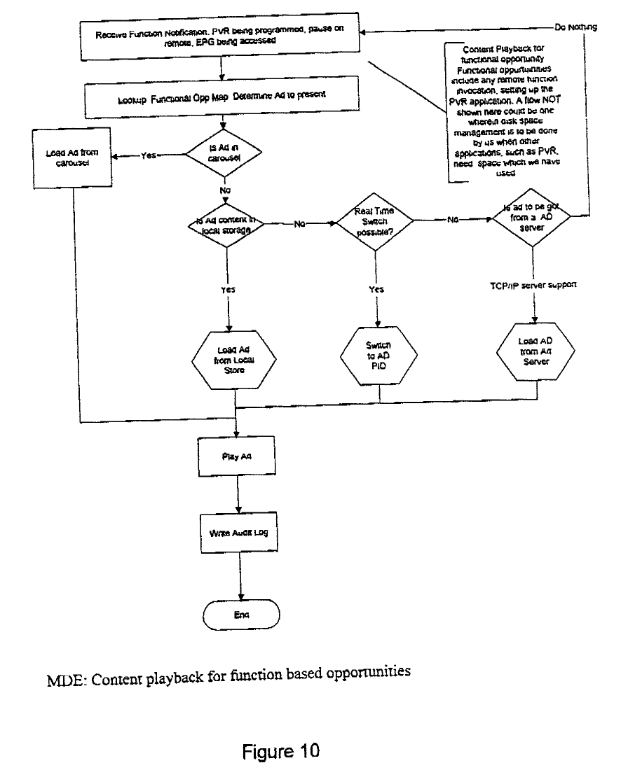

FIG. 11 shows a method for presenting targeted content system in accordance with the present invention.

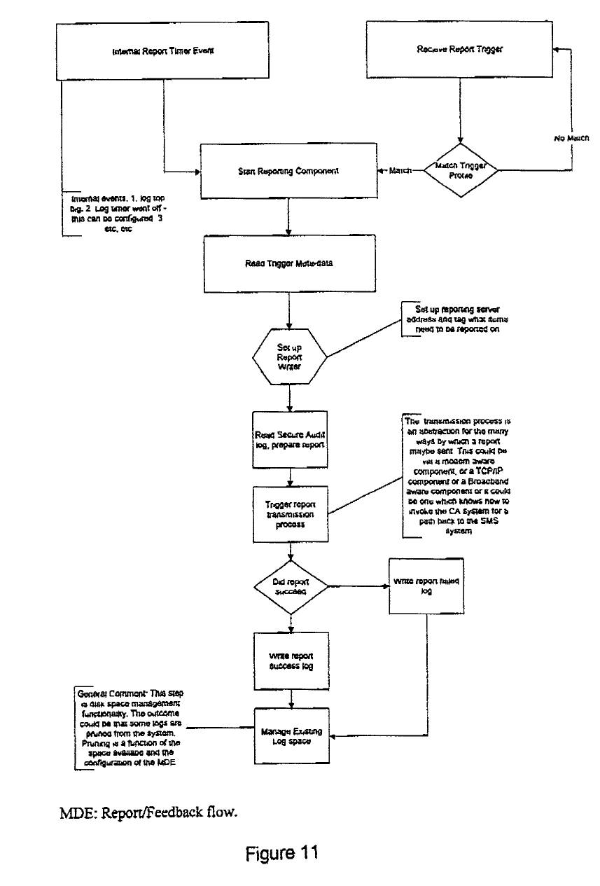

### DETAILED DESCRIPTION OF THE PRESENTLY PREFERRED EMBODIMENT

The present invention is directed to a method and system for automated reporting in a communications network.

In accordance with the present invention, there is provided a method for automated reporting in a communications network, the method comprising the steps of: collecting user data related to content targeting; and reporting said collected data to provide improved targeting.

In accordance with the present invention, there is provided a method for automated reporting in a communications network, the method comprising the steps of: monitoring the programming stream for opportunities and content descriptors; determining the source for alternate content as described previously; matching the opportunity to the available content and the viewer characteristics; presenting the content to the viewer; and updating the secure audit log with the viewing result.

In one embodiment of the present invention, the system includes a delivery engine, a matching engine, a combiner, and an MDE. The MDE has sub-components including a base MDE, a feedback manager, a targeting manager, a presentation manager and a storage manager. The ME, DE, and combiner are all situated in the network's broadcast head-end. MDE's are located at network points and/or on receivers connected to viewing devices such as televisions and personal computers.

The MDE applies the final decision as to how to provide the best choice in targeting content to the viewer and to report back the action performed. To do this it has the responsibility of understanding regular broadcast schedules, functional opportunities, collecting appropriate targeting content, setting and managing up demographic profiles, create and manage audit logs. The MDE also interacts with receiver based conditional access systems in order to provide authentication, authorization and privacy.

The invention provides for reporting viewing records and habits to a data collection system. The invention is suitably used with Cellular telephony; Cable networks; Consumer kiosks such as ATMs; DSL; and IP based networks.

The reporting component can further provide facilities to determine which viewer in a multi-viewer household was watching content without requiring active input from the user. In an embodiment of the present invention, biometric mechanisms are included in end-user equipment such as the receiver or remote control to improve viewer identification precision. In an embodiment of the present invention, the remote control includes a fingerprint reader. The remote control cannot be used unless the appropriate finger is in the reader portion of the device to identify the user. Methods such as the selection of a viewer profile on the receiver can be used.

In an embodiment of the present invention, viewer inputs to the system are recorded, whether from a remote control, keyboard, front panel switches or other input devices. The analysis of keystroke and content selection, timing and combinations can determine, with high probability, which household viewer is currently using the system. Inputs can be analyzed in the receiver or in servers on the operators network.

Other embodiments of the network include direct to home satellite or microwave television distribution system, XDSL and ATM networks, terrestrial television broadcast, cellular telephone, and other networks, and the same or related networks like standard telephone connections for returning data from the receiver.

When content is presented and viewed, the receiver can record the results of the content view in secure storage and report the results to a reporting facility. Based on the results, content providers can further tailor content and parameters to match content with desired viewer.

Another example of the use of secure facilities for storage of data and execution of methods is the maintaining of confidentiality of viewing records, even when use of those records is required for assessing the appropriate content to show when a content viewing opportunity arises.

The presentation methods in the presentation manager function of the MDE can also handle and manage viewer input to control the triggering of functional opportunities. The logging of results can include all inputs from the user. These inputs can be processed within the receiver or at a network site to as part of the analysis of viewing habits and, based on the frequency, selection of inputs, and the resulting content selections, can be used to identify the viewer with a reasonable probability.

The detail level of the logging of the interactions and selections can be based on user selections and permissions performed at the receiver, or based on agreements between the network operator and the viewer, with the operator transmitting permissions to the receiver to set the logging level based on the agreements. These agreements can include some form of payment, discount or other credit for the user.

The reporting methods can process the data to produce derived data for subsequent targeting opportunities. The processing and storage of the resulting data can be performed in whole or in part within the facilities of a conditional access system (CAS). Following processing and reporting of data, the reporting methods manage the space used by the data, and can delete data based on temporal factors, completion of processing, reporting and other considerations.

In one embodiment of the present invention, inputs to the system are recorded, whether from a remote control, keyboard, front panel switches or other input devices. The combination of keystrokes and content selection, through analysis, can determine with a high probability which viewer in the household is currently using the system. The inputs can be analyzed in the receiver or in servers on the operators network.

In one embodiment, a CAS, normally used for impulse pay-per-view purchase recording, can perform results and reporting. The CAS reports both content targeting data and pay-per-view purchase data within the same telephone call to reduce operator telephone toll costs.

The detail level of the reporting of the interactions and selections can be based on user selections and permissions performed at the receiver, or based on agreements between the network operator and the viewer, with the operator transmitting permissions to the receiver to set the logging level based on the agreements. These agreements can include some form of payment, discount or other credit for the user.

Inputs and viewing records can be stored and transmitted securely, and can use available conditional access features. The reporting process is governed by the capabilities of the receiver, and can be performed in real-time or on a deferred basis. Deferred methods are particularly important when a reporting network is a telephone network and an operator is paying toll charges for the telephone call. An aggregation and occasional reporting of stored data can result in substantial cost savings.

Once the MDE targets and presents content, it logs information such as what content was played, time it was played and demographic match processed to arrive at the presentation decision. The MDE activates the reporting component based on reporting triggers it receives from internal settings such as time of day alarms, and/or specific interaction at the receiver or external real-time triggers from the matching engine and delivery engine. When activated, the reporting component will transmit the logged information as required by the head-end trigger. This trigger also contains the address and phone number to be connected to for sending the reporting information.

As well, triggers can be demographic based and/or statistically based to manage the volume of data reported. As an example, a trigger can be created for all receivers in a particular postal code area to signal their reporting agent to activate. This can be especially beneficial to satellite MSO's whose broadcasts are transmitted over a wide geographical area, but who only want feedback from specific locations. Segregating the call back in this fashion also allows TELCO-based return systems to load balance their reporting mechanisms so that different postal codes are assigned different phone number end-points for reporting. The server components at the end of these phone number end-points can then aggregate the localized reporting and use more robust networks, such as broadband IP networks, to send the data to a bank of central servers at a control center.

In an embodiment of the present invention, reporting is performed by a conditional access system (CAS) normally used for impulse pay-per-view purchase recording. The conditional access system can report both content targeting data and pay-per-view purchase data within the same telephone call to reduce operator telephone toll costs. In an embodiment of the present invention, the system is deployed in a broadcast environment where the network operator uses satellite transmission to viewing devices and TELCO-based return to the network operator's site, typically referred to as the head-end. Other secure subsystems can be used and are known to those of skill in the art.

The MDE is either embedded within the receiver software or is streamed out by the delivery engine through the combiner and loaded onto the receiver from the broadcast stream. The MDE can examine the receiver environment and available functionality and uses this information to load its constituent components. In one embodiment being described the base MDE determines that the return path to the head-end is via a TELCO phone line and loads the appropriate reporting component that understands the specifics of dealing with phone lines.

The delivery engine and spooler send, via the broadcast network, meta-data and triggers to the MDE for the purposes of content delivery, capture, targeting, presentation, and feedback. Meta-information for reporting is sent via middleware infrastructures which collect information from the combiner and broadcast this information to the receivers using standard digital broadcast equipment such as MPEG2 multiplexes and encoders.

The matching engine and delivery engine also send down configuration triggers that indicate to the MDE if certain components need to be replaced. This allows for dynamic adaptation of the system to new feedback algorithms, better functional capability, and bug fixes to component code.

At anytime an MDE can replace itself in while or in part with another MDE available on the carousel or the MDE may remain resident on the receiver. This gives the system the ability to modify its reporting mechanism dynamically. This flexibility can be carried back up the supply chain to allow the originators of targeted content to customize methods used to target that content on a per instance basis.

Different viewer configurations can have different reporting components based on the receiver's capability and environment. The MDE can in real-time update its reporting sub-system to reflect the receiver hardware configuration For example, for receiver's with a modem connection, a reporting component that knows how to deal with modems can be downloaded. Similarly, IP-enabled receivers can use an IP-aware reporting system.

The MDE present on the receiver will report targeting and presentation information based on triggers sent to it via a data carousel and/or other data transfer mechanisms. The MDE contains the reporting component, offering a solution with several advantages for Network Operators over existing systems. The trigger can be based on geographical or other targeting meta-data. Triggered reporting will be used to activate groups of MDE's in cases where feedback bandwidth is expensive. Triggers will also indicate what type and amount of report data is required.

Another advantage of the MDE architecture is that an MDE can reside inside or outside of security infrastructure provided on a receiver. Access to confidential information and receiver resources, such as disk access, can be restricted based on the request being generated by an MDE. For instance, requests for a subscriber's personal information and receiver recourses necessary to target content can be controlled based on the content targeting request, which channel, which advertiser. By taking into account the agency requesting the information and resources, and the nature of those requests, the MDE can work with existing conditional access system (CAS) or other security infrastructures to determine if the MDE may use those desired resources on behalf of the requesting agency.

The invention uses commercial infrastructure for the deployment and delivery of targeting applications and content. This means that Network operators who already operate with such infrastructure will be able to deploy the reporting system on existing environments with little or no new expenditure.

The system comprises control, management and distribution elements spanning from the placement at scheduling of content from the broadcaster and its proxies such as advertising-related agencies, through to multiple cable or satellite distribution networks, to the receiver at the customer premises, and in feeding back data from the viewing at the receiver to the appropriate systems. It also allows for reporting from a receiver-based MDE based on triggers/signals from a server at a broadcast head-end.

The invention has the ability to provide reporting feedback on targeted content selection and presentation, and has the ability to manage reporting bandwidth depending on the broadcast system. The invention has the ability to adapt the reporting capability depending on receiver/reporting environment. The invention has the ability to provide selective reporting on demand in a multicast broadcasting or point-to-point environment. The invention enables the ability to provide reporting through relatively low-bandwidth networks for existing satellite and microwave broadcasting systems, securely and at a reasonable cost, as well as over IP-based high-bandwidth networks.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A method for automated reporting in a communications network, the method comprising the steps of:
collecting user data related to content targeting; and
reporting said collected data to provide improved targeting.

2. The method according to claim 1, for automated reporting in a communications network for scheduled content opportunities, the method comprising the steps of:
a) monitoring the programming stream for opportunities and content descriptors;
b) determining the source for alternate content as described previously;
c) matching the opportunity to the available content and the viewer characteristics;
d) presenting the content to the viewer; and
e) updating the secure audit log with the viewing result.

3. The method according to claim 1, for automated reporting in a communications network for functional content opportunities, the method comprising the steps of:
a) monitoring the programming and content streams for opportunities and content descriptors;
b) pre-matching the opportunities to the available content and viewer characteristics;
c) determining the source for alternate content as described previously;
d) at function invocation, checking security rights determining appropriateness of a content insertion;
e) if appropriate, presenting the content to the viewer;
f) updating pre-matched opportunities for next function invocation; and
g) updating the secure audit log with the viewing result.

4. A system for automated reporting in a communications network comprising
means for collecting user data related to content targeting; and
means for reporting said collected data to provide improved targeting.

5. A system for automated reporting in a communications network comprising:
a microdecision engine for collecting user data; and
a means for transmitting said data to head-end components.

6. A storage medium readable by a computer, the medium encoding a computer process to provide a method for automated reporting in a communications network, the computer process comprising:
a processing portion for collecting user data related to content targeting; and
a processing portion for reporting said collected data to provide improved targeting.
